(19) United States
(12) Patent Application Publication
(10) Pub. No.: US 2015/0216103 A1
(43) Pub. Date: Aug. 6, 2015

(54) TURF MAINTENANCE DEVICE AND ADJUSTMENT DEVICE FOR SAME

(71) Applicant: Allen Shane Barnett, Naples, FL (US)

(72) Inventor: Allen Shane Barnett, Naples, FL (US)

(21) Appl. No.: 14/613,962

(22) Filed: Feb. 4, 2015

Related U.S. Application Data
(60) Provisional application No. 61/935,997, filed on Feb. 5, 2014.

(51) Int. Cl. A01B 45/02

(52) U.S. Cl. CPC A01B 45/023; A01B 45/026

(57) ABSTRACT

Turf maintenance devices and adjustment devices for use with turf maintenance devices are provided. A turf maintenance device includes a plurality of blades each rotatable about a central axis, a housing supporting the blades, a frame, and a plurality of wheels. The turf maintenance device further includes an arm assembly comprising a first arm and a second arm spaced apart from the first arm. The turf maintenance device further includes an actuator coupled to the housing and operable to adjust a position of the housing, the actuator movable between a first position and a second position, and an electronic control system in operative communication with the actuator.

This application claims priority to U.S. Provisional Patent Application Ser. No. 61/935,997, filed Feb. 5, 2014, entitled “TURF MAINTENANCE DEVICE AND ADJUSTMENT DEVICE FOR SAME”, which is incorporated by reference herein in its entirety.

### FIELD OF THE INVENTION

The present disclosure relates generally to turf maintenance devices, and more particularly to actuators for use with turf maintenance devices.

### BACKGROUND OF THE INVENTION

Various turf maintenance devices are generally known in the art for use in various applications. In particular, turf maintenance devices may be utilized in golf course management applications to treat, for example, the various grasses and grounds on the golf course.

One example of a turf maintenance device is an aerator. Aerators typically include a plurality of tines operatively connected to a driveshaft and are independently powered or coupled to a power take-off shaft of a tractor or the like. As the driveshaft turns, the tines alternately puncture the surface of the ground and remove plugs or cores of soil, which helps to improve the quality of the turf covering the ground. Aerators are expensive and because of their function are limited in use to one to two applications per year.

Another example of a turf maintenance device is a vertical cutting device, or verticutter. Vertical cutting devices typically include a plurality of blades radially connected to a driveshaft. As the driveshaft turns, the vertical blades make a series of small vertical cuts in the ground, cutting runners in the turf and removing thatch and other dead foliage from the surface.

In some cases, verticutters are utilized in areas having varying grass levels. Further, in many cases, it may be desirable to only cut into certain portions of the ground. For example, verticutters may in some applications be utilized to cut the grounds comprising the greens on a golf course, while it may not, be desirable to cut the grounds surrounding the greens, Accordingly, it is desirable to lift the blades away from the ground during operation, to prevent contact between the blades and the ground.

Known verticutters utilize a handle connected to the blades to adjust the height of the blades during operation. The handle is manually manipulated to provide such adjustment. Manual adjustment by pulling and pushing on a handle, however, is in many cases undesirable. For example, adjustment in many cases, such as when treating golf course greens, can be required multiple times, if not hundreds of times, during a treatment. This can be both time consuming and tiring.

Accordingly, improved adjustment devices for use with turf maintenance devices are desired. In particular, adjustment devices which facilitate more efficient adjustment of the blades of turf maintenance devices would be advantageous.

### BRIEF DESCRIPTION OF THE INVENTION

Aspects and advantages of the invention will be set forth in part in the following description, or may be obvious from the description, or may be learned through practice of the invention.

In accordance with one embodiment, a turf maintenance device is provided. The turf maintenance device includes a plurality of blades each rotatable about a central axis, a housing supporting the blades, a frame, and a plurality of wheels. The turf maintenance device further includes an arm assembly comprising a first arm and a second arm spaced apart from the first arm. The turf maintenance device further includes an actuator coupled to the housing and operable to adjust a position of the housing, the actuator movable between a first position and a second position, and an electronic control system in operative communication with the actuator.

In accordance with another embodiment, an adjustment device for a turf maintenance device is provided. The adjustment device includes an actuator, the actuator comprising a cylinder and a piston, the piston movable between a first position and a second position. The adjustment device further includes an electronic control system in operative communication with the actuator, and a shackle assembly for rotatably connecting the actuator to the turf maintenance device.

In accordance with another embodiment, an adjustment device for a turf maintenance device is provided. The adjustment device includes an actuator, the actuator comprising a cylinder and a piston, the piston movable between a first position and a second position. The adjustment device further includes an electronic control system in operative communication with the actuator, and a guide plate, the guide plate comprising a platform and a front panel generally transverse to the platform.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of two embodiments of a turf maintenance device in accordance with embodiments of the present disclosure;

FIG. 2 provides an opposing perspective view of two embodiments of a turf maintenance device in accordance with embodiments of the present disclosure;

FIG. 3 provides a perspective view of an adjustment device connected to a turf maintenance device in accordance with embodiments of the present disclosure;

FIG. 4 provides a side view of a shackle of an adjustment device connecting the adjustment device to a turf maintenance device in accordance with embodiments of the present disclosure;

FIG. 5 illustrates various components of an adjustment device for use with a turf maintenance device in accordance with embodiments of the present disclosure;

FIG. 6 provides a perspective view of an adjustment device connected to a turf maintenance device in accordance with other embodiments of the present disclosure;

FIG. 7 provides a side view of an adjustment device connected to a turf maintenance device in accordance with other embodiments of the present disclosure; and

FIG. 8 illustrates various components of an adjustment device for use with a turf maintenance device in accordance with other embodiments of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention, in fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

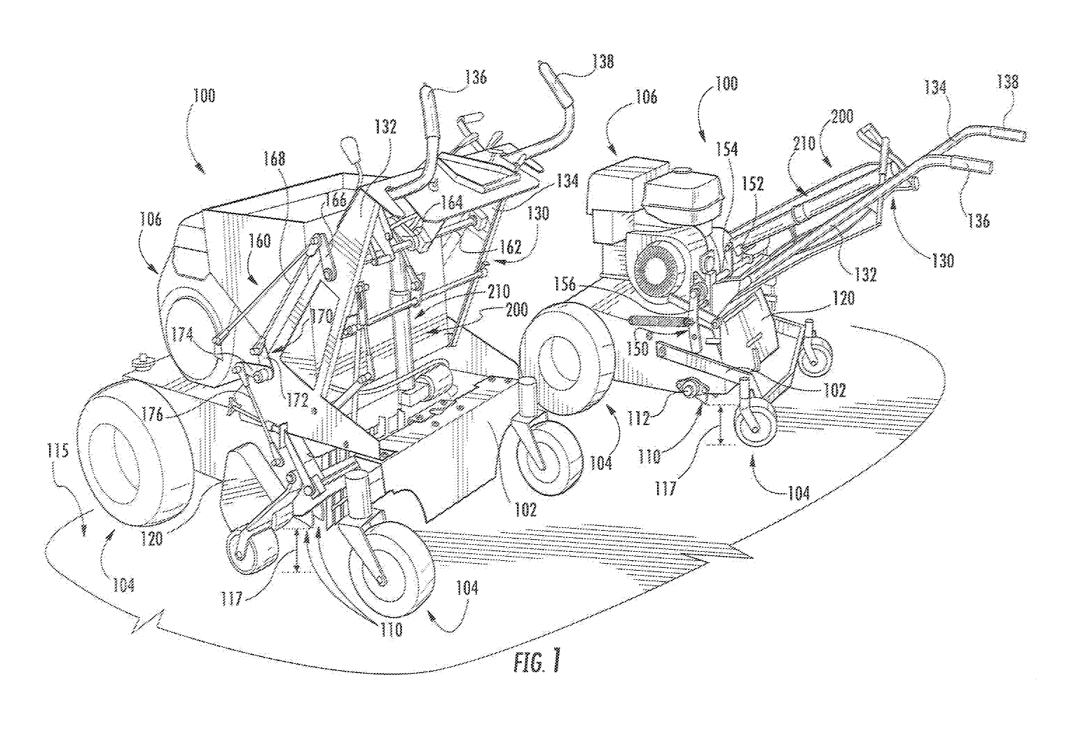

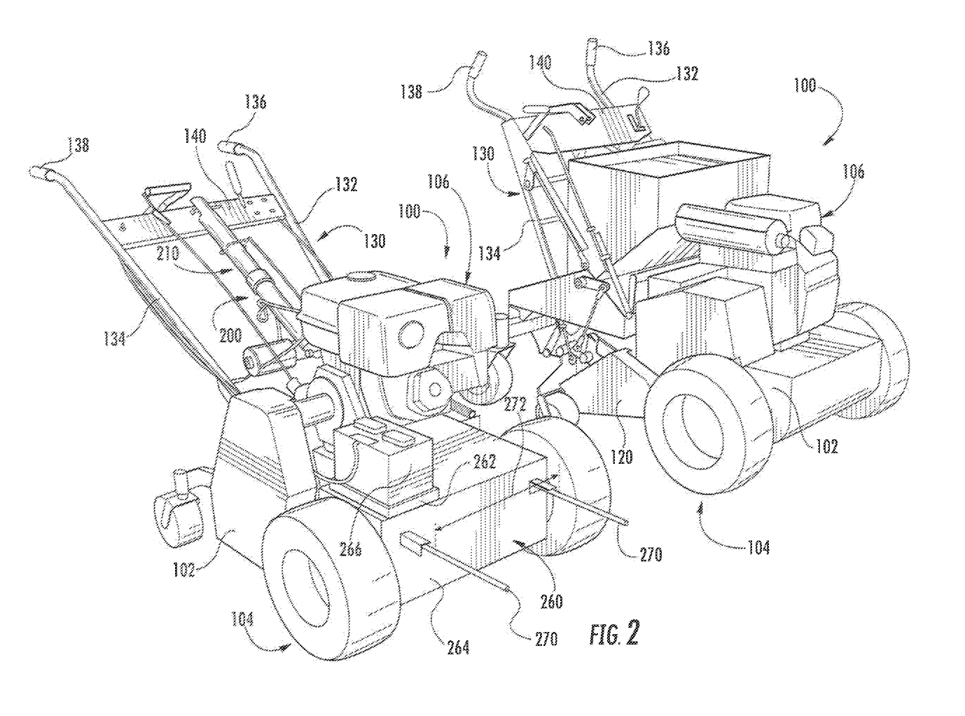

Referring to FIGS. 1 and 2, embodiments of a turf maintenance device are illustrated. As shown, a turf maintenance device 100 may generally include a frame 102 and a plurality of wheels 104, which may be rotatably mounted to the frame 102 or a housing 120 (discussed herein). A device 100 may generally define a vertical direction V, a lateral direction L, and a transverse direction T, all of which may be generally orthogonal to each other. The lateral direction L may be defined generally in the direction of travel of the wheels 104, while vertical direction V may be defined along a height of the device 100 and the transverse direction T may be defined along a width of the device 100.

Device 100 may further include a motor 106, which may be supported on the frame. Motor 106 may be in operative communication with the wheels 104 to facilitate movement of the device 100, and may further be in operative communication with blades 110 of the device 100 to facilitate rotation and thus operation of the blades 110. A suitable drivetrain (not shown) may additionally be included in the device 100 to facilitate operation.

Device 100 may further include a plurality of blades 110, as mentioned. Each blade 110 may, for example, be a generally circular blade having cutting teeth on an outer circumference thereof. Each blade may generally be rotatable about a central axis. The blades may be disposed in a linear array extending generally along the transverse direction T. A shaft 112 may generally along the transverse direction T, to which the blades 110 are coupled. Rotation of the shaft 112 may rotate the blades 110.

A housing 120 may support the blades 110 on the frame 102. Housing 120 may for example at least partially enclose the blades 110, such as generally on five sides. An opening in housing 120 may provide access for the blades 110 to contact the ground 115. A clearance height 117 may be defined between the blades 110 and the ground 115. The clearance height 117 may be a height that defines a minimum distance between a lowest point on a blade 110 and the ground 115. Blades 110 may be supported by the housing 120. For example, shaft 112 may extend through and be rotatably coupled to the housing 120. Alternatively, shaft 112 may be indirectly connected to the housing 120.

A device 100 may further include an arm assembly 130. The arm assembly 130 may generally extend from the frame 102, and may facilitate operator interaction with the device 100. For example, arm assembly 130 may include a first arm 132 and a second arm 134. The arms 132, 134 may be spaced apart from each other, such as along the transverse direction T. Handles 136, 138 may extend from the arms 132, 134 respectively, for an operator to grip when operating the device 100. A cross-panel 140 may extend between the arms 132, 134. The cross-panel 140 may be positioned proximate the handles 136, 138, and various instruments and components of the device 100 which an operator may desire to manipulate may be connected to the cross-panel 140.

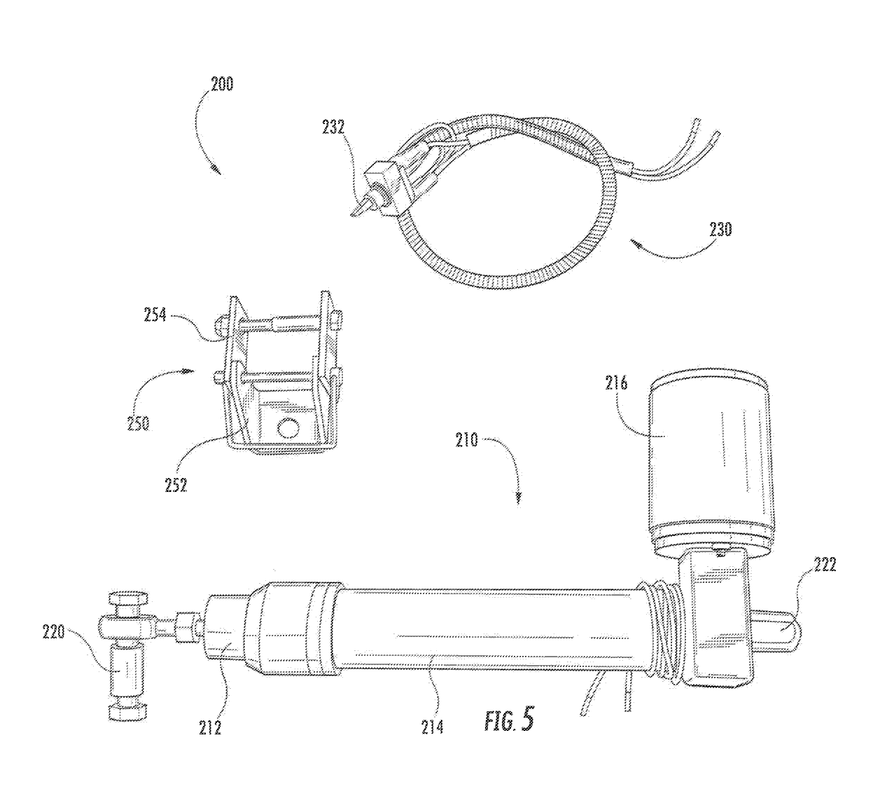

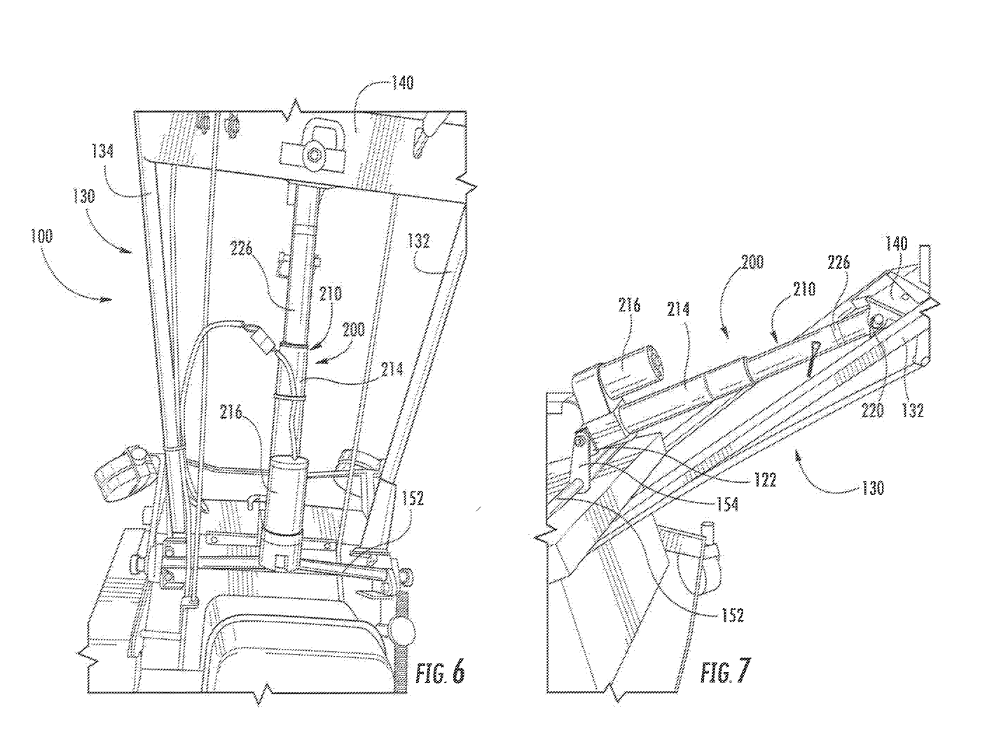

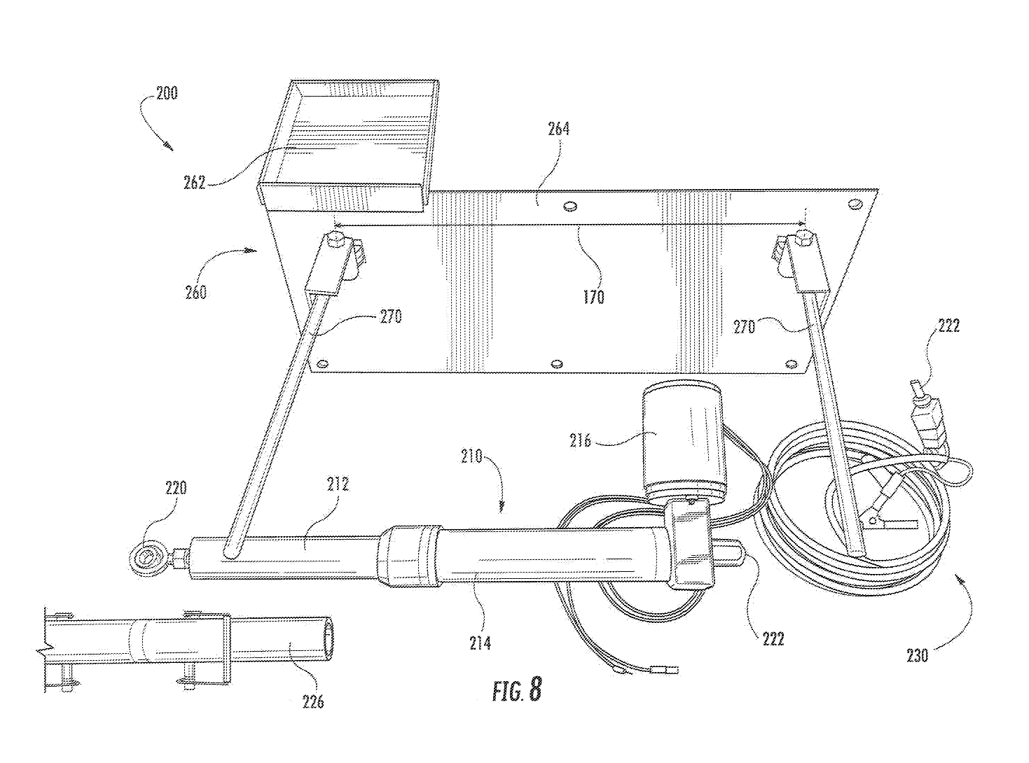

Referring now to FIGS. 1 through 8, a device 100 may further include an adjustment device 200. Adjustment device 200 may be utilized with device 100 to quickly and efficiently adjust the blades 110, such as specifically the clearance heights 117 of the blades 110. Adjustment devices 200 according to the present disclosure may advantageously replace manual adjustment components, such as manually adjustable arms, with, for example, actuatable components. Such actuatable components may be operated by, for example, an electronic control system, to quickly and efficiently adjust the blades 110 as desired. Additionally, adjustment devices 200 according to the present disclosure may be installed on newly assembled turf maintenance devices 100, or advantageously may be retrofit to existing devices 100.

An adjustment device 200 may include an actuator 210. The actuator 210 may be coupled to the housing 120, and may be operable to adjust a position of the housing 120, thus adjusting the position of and clearance heights 117 of the blades 110 supported by the housing 120. An actuator 210 according to the present disclosure is generally a device which includes a movable component that is operated by a source of energy, such as electric current, fluid pressure, mechanical rotation, etc. in exemplary embodiments as illustrated, actuator 210 may be an electric ball-driven actuator. In alternative embodiments, the actuator 2110 may be a fluid-driven actuator, such as a pneumatic actuator or a hydraulic actuator. The actuator 210 may include, for example, a piston 212 which is movable, such as along a linear path, relative to a cylinder 214. Actuator 210 may further include a motor 216 which may be operable to actuate the piston 212.

Actuator 210 may further include connectors 220, 222 for connecting the actuator 210 to the device 100. Connector 220 may extend from piston 212, and connector 222 may extend from the cylinder 214.

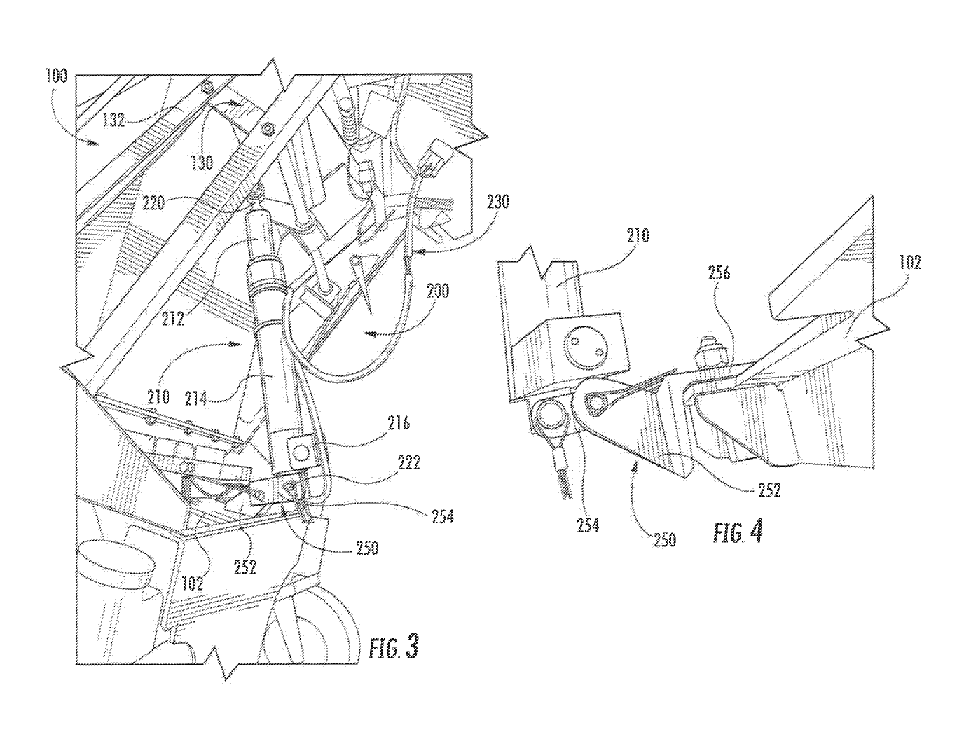

The actuator 210, such as the piston 212 thereof, may be movable between a first position and a second position. For example, the piston 212 may be movable between a first position wherein the piston 212 is retracted relative to the cylinder 214 (and to the piston in a second position) and a second position wherein the piston 212 is extended relative to the cylinder 214 (and to the piston in a first position). Pistons 212 in the second position are illustrated in FIG. 1, while a piston 212 in the first position is illustrated in FIG. 3.

In some embodiments, actuator 210 may additionally include a sleeve 226. The sleeve 226 may generally surround the piston 212, and may for example restrict movement of the piston 212 relative to the cylinder 214. For example, the sleeve 226 may prevent retraction of the piston 212 beyond a certain point due to interference between the piston 212 and the sleeve 226.

Device 200 may further include an electronic control system 230. The electronic control system 230 may be in operative communication with the actuator 210, and may be operable to actuate the actuator 210 as required. For example, electronic control system 230 may include a processor and a switch 232. The processor may be configured to send and receive signals from the actuator 210 regarding operation thereof, such regarding movement of the piston 212 between a first position and second position. As used herein, the term “processor” is not limited to integrated circuits referred to in the art as a computer, but broadly refers to a controller, a microcontroller, a microcomputer, a programmable logic controller (PLC), an application specific integrated circuit, and other programmable circuits, and these terms are used interchangeably herein. It should be understood that a processor and/or a control system can also include memory, input channels, and/or output channels. Switch 232 may be configured to provide an input to actuator 210 to operate the actuator 210, such as to move the piston 212 to the first position and to the second position as desired. Switch 232 may be operable by an operator of the device 200 and/or device 100 to obtain such actuator 210 operation. The electronic control system 230 may be connected to the actuator 210 via a suitable wired or wireless connection.

Referring to FIGS. 1, 3, 6 and 7, device 100 may further include a linkage assembly 150 for coupling the actuator 200 to the housing 120. A linkage assembly 150 may include, for example, a plurality of linkage components that translate movement of the actuator into movement of the housing 120. For example, referring to FIGS. 1, 6 and 7, in sonic embodiments, linkage assembly 150 may include a transversely extending cross-piece 152. The cross-piece 152 may for example extend between the first arm 132 and second assn 134. The cross-piece 152 may be proximate the housing 120. Further, the cross-piece 152 may be rotatable. The actuator 210 may be connected to and between the cross-piece 152 and the cross-panel 140. For example, the cylinder 214, such as the connector 222 thereof, may be connected to the cross-piece 152, and the piston 212, such as the connector 220 thereof, may be connected to the cross-panel 140. As illustrated a connection plate 154 may extend between and connect the cylinder 214, such as the connector 222 thereof, and the cross-piece 152. For example, connection plate 154 may be rotatably connected to the cylinder 214, such as the connector 222 thereof, and fixidly connected to the cross-piece 152. A linkage 156 may be connected to the cross-piece 152, such as to an end of the cross-piece 152. Linkage 156 may be fixidly connected to the cross-piece 152. Linkage 156 may additionally be connected to the housing 120, such as rotatably connected to the housing 120. Accordingly, movement of the actuator 210 may rotate the cross-piece 152, which may in turn rotate the linkage 156, which may in turn cause the housing 120 to pivot. Housing 120 may, for example, pivot relative to front wheels 104 mounted at a front end (in the lateral direction L spaced from the arm assembly 130) of the device 100. Pivoting of the housing may cause adjustment of the clearance height 117 of the blades 117. In exemplary embodiments, movement of the piston 212 to the first position may raise the clearance height 117, and movement of the piston 212 to the second position may lower the clearance height 117.

Referring to FIGS. 1 and 3, in other embodiments, a linkage assembly 150 may include a transversely extending cross-piece 162. The cross-piece 162 may for example extend between the first arm 132 and second arm 134. The cross-piece 162 may be distal from the housing 120 and proximate the cross-panel 140. Further, the cross-piece 162 may be rotatable. The actuator 210 may be connected to and between the cross-piece 162 and the frame 102. For example, the cylinder 214, such as the connector 222 thereof, may be connected to the frame 102, and the piston 212, such as the connector 220 thereof, may be connected to the cross-piece 162. As illustrated a connection plate 164 may extend between and connect the piston 212, such as the connector 220 thereof, and the cross-piece 162. For example, connection plate 164 may be rotatably connected to the piston 212, such as the connector 220 thereof, and fixidly connected to the cross-piece 162.

A cam 166 may be connected to the cross-piece 162, such as to an end of the cross-piece 162. Cam 166 may be fixidly connected to the cross-piece 162. A first linkage 168 may be connected, such as rotatably connected, to the cam 166. A cam assembly 170 may be connected, such as rotatably connected, to the first linkage 168. Cam assembly 170 may include first cam component 172 and a second cam component 174, which may be fixed relative to each other. First linkage 168 may be connected to the first cam component 172. A second linkage 176 may be connected, such as rotatably connected, to the second cam component 174, and thus to the cam assembly generally 170. Second linkage 176 may be connected, such as rotatably connected, to the housing 120. Accordingly, movement of the actuator 210 may rotate the cross-piece 162, which may in turn rotate cam 166, which may in turn rotate the first linkage 168, which may in turn rotate the cam assembly 170, which may in turn rotate the second linkage 176, which may in turn cause the housing 120 to pivot. Pivoting of the housing may cause adjustment of the clearance height 117 of the blades 117. In exemplary embodiments, movement of the piston 212 to the first position may raise the clearance height 117, and movement of the piston 212 to the second position may lower the clearance height 117.

Referring to FIGS. 3 through 5, adjustment device 200 may further include a shackle assembly 250. In embodiments wherein the actuator 210 is connected to the frame 102, the shackle assembly 250 may allow the actuator 210 generally to move or “float” relative to the frame 102, and thus allow the housing 120 and blades 110 to “float”. This is particularly advantageous when the device 100 is utilized on grounds having varying grass heights, etc. Shackle assembly 250 may include, for example, a bracket 252 and a tab 254. The bracket 252 may be fixidly connected to the frame 102, and the tab 254 may extend between the bracket 252 and the actuator 210, such as the cylinder 214, such as the connector 222 thereof. The tab 254 may be rotatably connected to the bracket 252 and the actuator 210. In some embodiments, as illustrated in FIG. 4, a mounting bracket 256 may additionally be provided. The mounting bracket 256 may be a generally L-shaped bracket, as illustrated. Mounting bracket 256 may be fixidly connected to and between the bracket 252 and the frame 102.

Referring to FIGS. 2 and 8, adjustment device 200 may further include a guide plate 260. The guide plate 260 may provide a visual guide for an operator using the device 100, and may further support various components of the device 100. For example, guide plate 260 may be mounted to the frame 102, such as to a front portion (in the lateral direction L) thereof, and may include a platform 262 and a front panel 264. The front panel 264 may generally transverse to the platform 262, and may extend generally in the transverse direction The platform 262 may support a battery 266 of the device 200, which may be connected to the actuator 210, such as to the motor 216 thereof, and/or electronic control system 230.

The guide plate 260 may further include a plurality of guide rods 270. Each guide rod 270 may be connected to and extend from the front panel 264. Further, the guide rods 270 may be rotatably connected to the front panel 264 in some embodiments, so that they can be folded against the panel 264 when not in use. When in use, the rods 270 may extend generally in the lateral direction L, and may be spaced apart by a width 272. The width 272 may be approximately equal to a width of the plurality of blades 110, such as between the outside blades 110 of the array of blades 110. Accordingly, the rods 270 may provide a visual approximation to an operator of the blade 110 width. This advantageously allows the operator to align the device 100 with portions of the ground that have already been cut with blades 110, and assure that no ground is missed by the blades 110.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A turf maintenance device, comprising:
a plurality of blades each rotatable about a central axis;
a housing supporting the blades;
a frame;
a plurality of wheels;
an arm assembly comprising a first arm and a second arm spaced apart from the first arm;
an actuator coupled to the housing and operable to adjust a position of the housing, the actuator movable between a first position and a second position; and
an electronic control system in operative communication with the actuator.

2. The turf maintenance device of claim 1, wherein the actuator is an electric ball-driven actuator.

3. The turf maintenance device of claim 1, further comprising a linkage assembly coupling the actuator to the housing.

4. The turf maintenance device of claim 3, wherein the linkage assembly comprises a cross-piece extending between the first arm and the second arm, a cam fixedly connected to the cross-piece, a first linkage rotatably connected to the cam, a cam assembly rotatably connected to the first linkage, and a second linkage rotatably connected to the cam assembly, wherein the actuator is connected to the cross-piece and the housing is connected to the second linkage.

5. The turf maintenance device of claim 4, wherein a piston of the actuator is connected to the cross-piece.

6. The turf maintenance device of claim 3, wherein the linkage assembly comprises a transversely extending cross-piece and a linkage connected to the cross-piece, wherein the actuator is connected to the cross-piece and the housing is connected to the linkage.

7. The turf maintenance device of claim 6, wherein a cylinder of the actuator is connected to the cross-piece.

8. The turf maintenance device of claim 1, further comprising a shackle assembly connecting the actuator to the housing.

9. The turf maintenance device of claim 1, wherein the shackle assembly comprises a bracket fixidly connected to the frame and a tab extending between the bracket and the actuator, the tab rotatably connected to the bracket and the actuator.

10. The turf maintenance device of claim 1, thither comprising a sleeve surrounding a piston of the actuator.

11. The turf maintenance device of claim 1, further comprising a guide plate mounted to the frame, the guide plate comprising a platform and a front panel generally transverse to the platform.

12. The turf maintenance device of claim 1, wherein the platform supports a battery, the battery connected to the actuator.

13. The turf maintenance device of claim 1, wherein the guide plate further comprises a plurality of guide rods.

14. An adjustment device for a turf maintenance device, the adjustment device comprising:
an actuator, the actuator comprising a cylinder and a piston, the piston movable between a first position and a second position;
an electronic control system in operative communication with the actuator; and
a shackle assembly for rotatably connecting the actuator to the turf maintenance device.

15. The adjustment device of claim 14, wherein the shackle assembly comprises a bracket and a tab, the tab rotatably connectable to the bracket and the actuator.

16. An adjustment device for a turf maintenance device, the adjustment device comprising:
an actuator, the actuator comprising a cylinder and a piston, the piston movable between a first position and a second position;
an electronic control system in operative communication with the actuator; and
a guide plate, the guide plate comprising a platform and a front panel generally transverse to the platform.

17. The adjustment device of claim 16, wherein the platform supports a battery, the battery connected to the actuator.

18. The adjustment device of claim 16, wherein the guide plate further comprises a plurality of guide rods.

19. The adjustment device of claim 16, further comprising a sleeve for surrounding the piston.
